(19) United States
(12) Patent Application Publication
(10) Pub. No.: US 2019/0104734 A1
(43) Pub. Date: Apr. 11, 2019

(54) Cure and prevent diseases in plants, bushes and trees using rhamnolipid liposomes

(71) Applicant: Keith DeSanto, St Petersburg, FL (US)

(72) Inventor: Keith DeSanto, St Petersburg, FL (US)

(21) Appl. No.: 15/946,049

(22) Filed: Apr. 5, 2018

Related U.S. Application Data
(63) Continuation-in-part of application No. 62/521,616, filed on Jun. 19, 2017.

(51) Int. Cl. A01N 43/16; A01N 25/04; C05G 3/00

(52) U.S. Cl. CPC A01N 43/16; C05G 3/0041; A01N 25/04

(57) ABSTRACT

This new Rhamnolipid Fertilizer discovery eliminates disease in plants, bushes and trees by breaking down the cells walls of bacteria causing diseases in plants, bushes and trees.

Because Rhamnolipid has both hydrophilic and hydrophobic components, Rhamnolipid facilitates its entry into cell membranes by breaking down the cell wall of bacteria. Bacteria Cell permeability is created by using this application.

Rhamnolipids are one of the most important biosurfactant types (Haba et al., 2013) and are mainly produced by the fermentation rote of Pseudomonas aeruginosa, but they also can be produced by Rhodotorula taiwanensis, Lactobacillus Plantarum, Pseudomonas Rhizophila, Pseudomonas Chlororaphis and Burkholderia sp. They are recognized as a “green production” due to their low environmental cytotoxicity, but they also have high emulsification potential and antimicrobial activities. The two components of Rhamnolipid consist of a hydrophilic (water attracting) part and a hydrophobic (water hating) part. Because rhamnolipid is amphipathic (having both hydrophilic and hydrophobic parts), this characteristic makes it easy to penetrate cell membranes of bacteria that cause disease.

### RHAMNOLIPID PRODUCTION

The production medium consisted of a Ca-free mineral salt solution with 15.0 g/L NaNO3, 0.5 g/L MgSO4×7 H2O, 1.0 g/L KCl and as a phosphate source 0.3 g/L K2HPO4. As sole carbon source soybean oil with a starting concentration of 250 g/L was used and 1 mL/L of the above-mentioned trace element solution was added.

The trace element solution contained 2.0 g/L sodium citrate×2 H2O, 0.28 g/L FeCl3×6 H2O, 1.4 g/L ZnSO4×7 H2O, 1.2 g/L CoCl2×6 H2O, 1.2 g/L CuSO4×5 H2O, and 0.8 g/L MnSO4×H2O. The fermentation was carried out at 37° C., pH 6.9, and the process was carried out for 158 h. The rhamnolipid produced was purified by acidification and then an extraction was carried out using ethyl acetate.

The molecular weight of the rhamnolipid is between 475 g/mol and 677 g/mol.

Because Rhamnolipid has both hydrophilic and hydrophobic components, Rhamnolipid facilitates its entry into cell membranes by breaking down the cell wall of bacteria causing diseases in plant, bushes and trees. Mixing the rhamnolipid with liposomes, increases the effect rate.

1. Mixing rhamnolipid liposomes with fertilizers and injecting the mix into the stem, root, trunk, or branch of a plant, a bush or a tree to cure and prevent diseases affecting plants, bushes and trees.

2. Mixing rhamnolipid liposomes with a fertilizer and spraying or soaking the stem, root, trunk, leaves or branch of a plant, a bush or a tree to cure and prevent diseases affecting plants, bushes and trees.
